(19) United States
(12) Patent Application Publication
(10) Pub. No.: US 2021/0006651 A1
(43) Pub. Date: Jan. 7, 2021

(54) METHOD, SYSTEM, AND APPARATUS FOR AUTOMATICALLY SETTING MOBILE DEVICE PROPERTIES VIA WIRELESS SIGNALING AND PROXIMITY

(71) Applicant: Romain Brabant, Nassau - New Providence (BS)

(72) Inventor: Romain Brabant, Nassau - New Providence (BS)

(21) Appl. No.: 16/502,546

(22) Filed: Jul. 3, 2019

(51) Int. Cl. H04M 1/725

(52) U.S. Cl. CPC H04M 1/72569

(57) ABSTRACT

A method, system, and apparatus, including a mobile device and a smart block, for automatically setting mobile device properties via wireless signalling and proximity.

### BACKGROUND

The balance between the advantages of mobile devices, including their mobility, ease of access to the internet, and the utility of instant notifications, and their disadvantages, such as their tendency to distract the user from other tasks through notification interruptions and their power to withdraw the user from the world around them, is frequently discussed and commonly criticized in our culture today.

Mobile devices commonly feature “do not disturb” (or DND) settings, but these settings must be actively engaged by the user in order to operate. However, habits are difficult to develop, people are forgetful, and time is short, so users may not have the instinct to engage the DND settings, the user may be preoccupied with work, or be under too tight a deadline. Unfortunately, even though the user may be reminded to engage DND mode when the mobile device rings or vibrates, concentration will already have been lost, and once it is lost, it is difficult to “get back into the groove”, so to speak. It is important to note that once a user begins interacting with the mobile device, even with the intention of eliminating its interruptive features, the ease of access to applications may derail the user from that intention, possibly leading to half an hour or more of undesirable distraction.

Even more important than one's concentration is one's need for sleep, and the notifications may wake up not only the user but the user's partner, parent, or child. While mobile devices may be programmed to enter DND mode at specific times, such as when the user tends to go to sleep, it is notoriously common for a user's sleep schedule to be erratic, especially with the demands of work, family, and recreation. The natural counterpart of the time at which one goes to sleep is the time at which one wakes up, which may be similarly erratic. As such, the default sleep schedule may not match the user's actual sleep start and end points, and may therefore interrupt it. The DND setting can be manually operated by the user, but in addition to having to remember to turn it on before sleeping, the user has to remember to turn it off upon waking.

Settings that compromise the interruptive quality of notifications, such as vibrations, may be less distracting than ringtones, but are to that same degree less effective at providing notifications, and therefore it is not a feasible strategy for one to always have one's phone set on vibration mode. Further, even if the interruptive quality of the notifications is limited, it is not eliminated, and vibrations are still capable of distracting one by drawing one's attention to the phone. Even if one only has the intention to check the phone to determine the caller or notification, one might then be drawn into engaging with the phone. Additionally, the vibrations are still loud enough to wake light sleepers, especially if the mobile device is placed directly on a hard surface, such as a night-stand or dresser. If phone's vibrations or sounds wake up sleepers, the user may then decide to engage with the phone to prevent future vibrations or sounds, but then the light emitted while engaging with the user interface compounds the matter upon an additional sense-perception.

The interruptive quality of notifications and the problems with mitigating it is not limited to one's own work and concentration, but also to one's social life, including friends and family. For example, it is an iconic cliche in our culture today for individuals to be having lunch or dinner together, but instead of spending time talking to one another, people spend the entire duration of the meal scrolling through applications or texting other people. It is an amusing but regretable spin on this cliche for the individuals to even be texting each other despite being only a few feet apart from each other. This phenomenon and culture's commentary on it also extends to the business context, such as in a board room meeting or round table discussion.

What is needed is a way to engage the DND settings or other notification dampening modes without the risk of incorrect and inappropriate automation, requiring the user to actively engage those settings, the initial necessity of remembering to do so, or the temptation to engage with applications or surf the internet. Such a solution would effectively remind the user to engage the DND settings and to enable the user to engage the DND settings without interacting with the user interface.

### SUMMARY

In one embodiment, the apparatus comprises a physical platform, pad, block, sticker, or surface (the “Surface”). The Surface has a length, width, and thickness, with the contour enclosed by the length and width being substantially flat and configured to receive a mobile device (the “Device”). The Device would be placed by a user onto the Surface in order to enable the Surface to execute its functionality regarding the Device.

In one embodiment, the Surface may feature a top padded surface disposed on the top of a main body, with a bottom padded surface disposed beneath the main body. The top padded surface is configured to be substantially in contact with the Device, and is preferably made of a cloth, velvet, microfiber, or other soft material that provides cushioning and prevents scratching of the Device. The bottom padded surface is similarly constructed and configured to be placed on top of a furniture surface, such as a table or nightstand. The main body is constructed of a hard or semi-hard shell and includes therein or thereon a wireless protocol chip or tag.

In one variation, the main body includes a contact force sensor configured to receive a contact force. This contact force may be measured in terms of magnitude or as a binary fact, though the binary fact may be actuated when the magnitude of the contact force exceeds a certain limit. The contact force sensor may be oriented from the main body to the bottom padded surface, or from the main body to the top padded surface. It may measure or detect a contact force being applied by the Device directly, an intermediary, or the furniture surface it is placed upon. In another variation, the main body may include multiple contact force sensors, each disposed in a different area of the main body. In yet another variation, the wireless protocol chip or tag includes or operates as a proximity sensor. In this variation, the contact force sensor is not necessary.

In one embodiment, the system comprises the Surface described above and a software application (the “Application”), with the Application installed on the Device. The Application is configured to access the notification settings on the Device, particularly the notification sounds such as ringing and vibrations. The Application may include multiple schedules, with each schedule adapting a unique set of notification configurations. For example, one schedule may adjust all notifications to vibration mode, another schedule may adjust all notifications to silent mode. In another example, one schedule may adopt the Do Not Disturb Mode. In one variation, a schedule may accept exceptions or alternate settings for a list of one or more notification sources. For example, the general setting may be silent mode, but the user may designate certain contacts to be set to vibration or ringing mode. The schedules may be selected and set via the Application's user interface.

In another embodiment, the Surface electronically couples to the Device, via one or more wireless protocols. Coupling is the status of one instrument recognizing another instrument and being able to transmit and/or receive data therefrom. This coupling is recognized by the Application, triggering a pre-set series of commands, including the configuration of the notification settings.

In one variation, the Surface and Device only electronically couple when actual physical contact is made between them. In another variation, configuration of the notification settings only occurs upon contact, even though electronic coupling may occur prior. In yet another variation, the Surface and Device couple when some pre-set proximity is obtained, for example, less than an inch.

In one embodiment, the Surface and Device are each equipped with RFID tags and couple via radio frequency. The RFID tags are preferably passive tags, because of the shorter lifespan of active tags, their extra expense, and their need for power, and because only a limited range of wireless connectivity is required for the Application functionality. An active RFID tag in the Device may share the power source of the Device, whereas an active RFID tag of the Surface may have an independent power source, such as a battery or an outleg plug. In one variation, the Surface RFID tag may have multiple transmitters to separately engage multiple Devices. A passive RFID tag may be powered by the radio frequency energy transmitted from RFID readers/antennas. Additional or alternative wireless protocols, such as Bluetooth, infrared, NFC (near-field communication) are also viable. NFC in particular is beneficial because it requires a 4cm or less distance in order to initiate communication.

In one embodiment, if multiple contact force sensors are disposed in/on the Surface, then each contact force sensor may be associated with a separate schedule, so that the user can select the schedule by engaging the contact force sensor rather than by navigating the Application user interface. In another embodiment, a given contact force sensor may detect different tiers of force thresholds, particularly short bursts of force or pulses. These pulses may similarly be associated with separate schedules. In yet another embodiment, one or more tags, chips, or sensors may be configured to determine the facedness, directionality, and/or orientation of the Device. For example, placing the Device monitor-side-up may be associated with one schedule while placing it monitor-side-down may be associated with another schedule. Placing the Device along an axis of the Surface and toward one end of that axis is associate with a first schedule, toward the other end of that axis, a second schedule, orthogonal to the axis and in a first direction, a third schedule, orthogonal to the axis and in a second direction, a fourth schedule, etc.

### BRIEF DESCRIPTION OF THE DRAWINGS

FIG. 1 shows exemplary exterior views of the smart block and mobile device.

FIGS. 2 shows exemplary interior views of the smart block and mobile device.

FIG. 3 is a flowchart showing exemplary steps of coupling the smart block to the mobile device and modifying the notification settings.

FIG. 4 is a flowchart showing an exemplary schedule setting.

### DETAILED DESCRIPTION

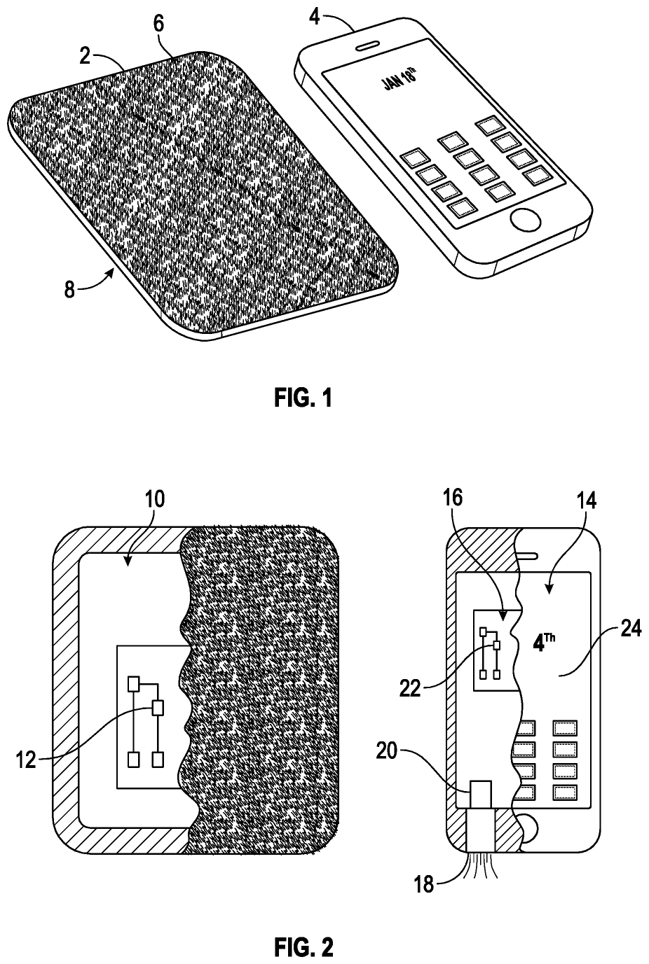

As shown in FIG. 1-2, the system includes a smart block 2 and a mobile device 4. The smart block may include a top face 6 and a main body 8. The main body includes a first coupling instrument 12 either embedded or in an interior space 10. The mobile device includes a touch-screen 14, a user interface 24 displaying on the touch-screen, a processor 16, a second coupling instrument 22, a speaker 18, and a vibrator 20. The second coupling instrument, speaker, and vibrator may be electronically and/or mechanically connected to the processor.

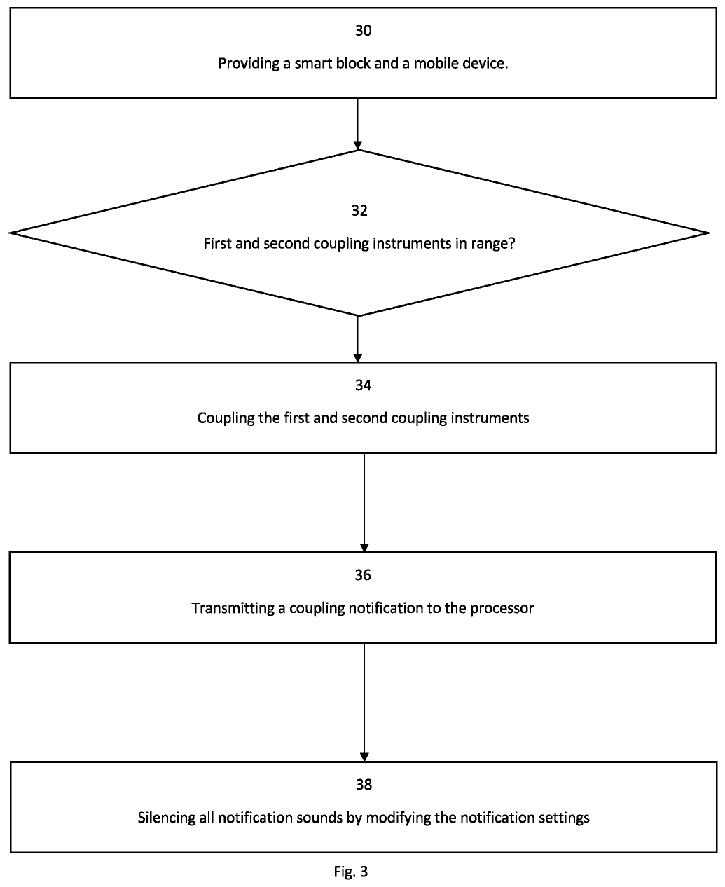

As shown in FIG. 3, the method of silencing notifications on a mobile devie may include 30 providing a smart block and a mobile device, 32, determining if the first coupling instrument of the smart block is within range of the second coupling instrument of the mobile device, and if so, 34, coupling them, 36 transmitting a coupling notification to the processor of the mobile device, and 38 silening all notification sounds by modifying the notification settings.

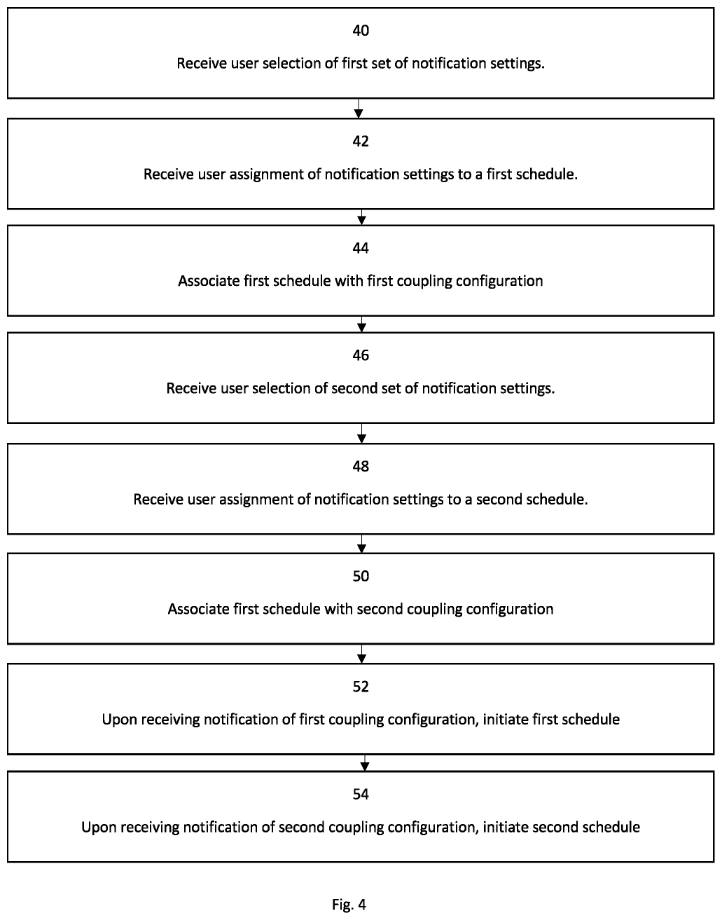

As shown in FIG. 4, the user interface may permit users to select various notification settings 40 and 46, which may include matching notification types (silence, vibration, ringing) magnitude (volume, intensity, duration), and events (receiving a message, a call, an email, an update from an application, etc.). These notification settings may be assigned to various schedules 42 and 48, and the schedules may be then associated with various coupling configurations 44 and 50. These configurations may be based on the location and/or orientation in which the mobile device is placed on the smart block, such as above or below an x axis, in a first, second, third, of fourth quadrant, at some number of degrees away from a y axis, a magnitude away from a center, closer to one coupling device or another coupling device, etc.

1-20. (canceled)

21. A system comprising a smart block and a mobile device;
the smart block having a main body, a top face, and a bottom face and configured to enable modification of notification settings of the mobile device when the mobile device is placed by a user onto the top face;
the top face and the bottom face being substantially equal in size and shape and having matching and flat outer contours;
the top face configured to be in physical contact with the mobile device;
the bottom face configured to be placed on top of a furniture surface and to be in flush contact with the furniture surface;
the main body being disposed between the top face and the bottom face and enclosing a first coupling instrument; the smart block having a first length, a first width, and a first thickness, the first length, first width and first thickness fully enclosing the top face, the bottom face, and the main body;
the mobile device having a second length, a second width, and a second thickness, the second length, second width, and second thickness fully enclosing a touch-screen, a processor, a user interface, notification settings, a speaker, a vibrator, and a second coupling instrument;
the second coupling instrument configured to detect the first coupling instrument when the mobile device is placed on top of the smart block, and upon detecting the first coupling instrument, transmit a coupling notification to the processor;
the processor programmed to, upon receiving the coupling notification from the second coupling instrument, silence all notification sounds by modifying the notification settings;
the first length being larger than the second length, the first width being larger than the second width, and the first thickness being smaller than the second thickness.

22. The system of claim 21, the first and second coupling instruments being wireless protocol components.

23. The system of claim 22 the wireless protocol components being RFID tags or RFID readers and configured to couple via radio frequency.

24. The system of claim 22 the wireless protocol components configured to couple via infrared, NFC, or Bluetooth.

25. A system comprising a smart block and a mobile device;
the smart block having a main body, a top face, and a bottom face and configured to enable modification of notification settings of the mobile device when the mobile device is placed by a user onto the top face;
the top face configured to be in physical contact with the mobile device;
the bottom face configured to be placed on top of a flat surface and to be in flush contact with the flat surface;
the main body enclosing a first coupling instrument;
the mobile device comprising a touch-screen, a processor, a user interface, notification settings, a speaker, a vibrator, and a second coupling instrument;
the second coupling instrument configured to, upon detecting the first coupling instrument, transmit a coupling detection notification to the processor.

26. The system of claim 25, the smart block additionally comprising a contact force sensor, the contact force sensor configured to detect a contact force;
the contact force sensor configured to, upon detecting a contact force, transmit a notification of the contact force to the first coupling instrument,
the first coupling instrument configured to, upon receiving the notification of the contact force from the contact force sensor, transmit the notification of the contact force to the second coupling instrument,
the second coupling instrument configured to, upon receiving the notification of the contact force from the first coupling instrument,
transmit the notification of the contact force to the processor;
the processor programmed to, upon receiving the notification of the contact force from the second coupling instrument, silence all notification sounds by modifying the notification settings.

27. (canceled)

28. The system of claim 25, the smart block or the mobile device additionally comprising a proximity sensor, proximity sensor configured to detect a predetermined proximity measurement between the smart block and the mobile device;
the processor programmed to, upon receiving a notification of the predetermined proximity measurement between the smart block and the mobile device, silence all notification sounds by modifying the notification settings.

29. The system of claim 21, the smart block having no structures extending above or around the mobile device when the mobile device is placed on the top surface, so that the mobile device can be placed on the top surface or removed therefrom without being impeded by structures and so that only one side of the mobile device is in contact with the smart block when the mobile device is placed on the top surface.

30. The system of claim 25, the smart block having no structures extending above or around the mobile device when the mobile device is placed on the top surface, so that the mobile device can be placed on the top surface or removed therefrom without being impeded by structures and so that only one side of the mobile device is in contact with the smart block when the mobile device is placed on the top surface.

31. The system of claim 25, the smart block additionally comprising a tag, chip, or sensor configured to determine mobile device positioning on the top face and configured to set the notification settings based on the mobile device positioning.

32.-40. (canceled)
